(19) United States
(12) Patent Application Publication
(10) Pub. No.: US 2025/0199162 A1
(43) Pub. Date: Jun. 19, 2025

(54) RADAR INTERFEROMETRIC TOMOGRAPHY FOR OPAQUE PARTICLE-LADEN FLOWS

(71) Applicant: The Board of Trustees of the University of Illinois, Urbana, IL (US)

(72) Inventors: Laura Villafane, Urbana, IL (US); Nicolas Rasmont, Champaign, IL (US); Hussein Al-Rashdan, Chicago Ridge, IL (US); Gregory S. Elliott, Dewey, IL (US); Joshua Lucas Rovey, Mahomet, IL (US)

(21) Appl. No.: 18/970,528

(22) Filed: Dec. 5, 2024

Related U.S. Application Data
(60) Provisional application No. 63/609,507, filed on Dec. 13, 2023.

(51) Int. Cl. G01S 13/89; G01N 11/02; G01S 7/35

(52) U.S. Cl. CPC G01S 13/89; G01N 11/02; G01S 7/356

(57) ABSTRACT

A system includes a reflector and a radar system positioned opposite from the reflector with an area under test therebetween having a particle-medium mixture. The radar system includes an antenna to emit, at the reflector, a series of chirps within a first electromagnetic signal and to receive a second electromagnetic signal that includes reflected chirps that bounce off the reflector. An ADC converts the second electromagnetic signal to a digital signal containing phase, frequency, and amplitude information. A processing device is to process the digital signal to: detect raw phase data of reflector peaks to be tracked over the reflected chirps; unwrap the raw phase data into a continuous phase-based signal; correct for phase non-linearities within the continuous phase-based signal; and generate, from the corrected continuous phase-based signal, a path-integrated particle number density for the particle-medium mixture.

### CLAIM OF PRIORITY

The present application claims the benefit under 35 U.S.C. § 119 (e) of U.S. Provisional Patent Application No. 63/609,507, filed Dec. 13, 2023, which is incorporated by reference herein.

### STATEMENT REGARDING FEDERALLY SPONSORED RESEARCH

This invention was made with government support under Award No. 80NSSC22K1332 awarded by NASA. The government has certain rights in the invention.

### TECHNICAL FIELD

Embodiments of the disclosure relate generally to radar interferometric tomography, and more particularly, to radar interferometric tomography for opaque particle-lade flows.

### BACKGROUND

Experimental research in multiphase flows has benefited from the rapid development of high-speed and high-resolution cameras in the last two decades. While essential for dilute conditions, quantitative concentration measurements via imaging are challenged as concentration increases due to apparent particle overlap and ghost particles. Laser and phase Doppler anemometry and laser diffraction techniques are also commonly used to measure particle concentrations, velocities, and/or size. These techniques are most suitable for dilute conditions, with measurement uncertainties that increase with concentration. At volume fractions above 0.1% to 0.01%, depending on the particle size and material properties, optical diagnostics fail due to the opacity of the particle-fluid mixture. Measurements in particle-laden flows also face other challenges absent in single-phase flows, as particles can coat or damage experimental hardware through erosion, impact, mechanical jamming, or triboelectric charging, hindering the use of classical intrusive instrumentation.

### BRIEF DESCRIPTION OF THE DRAWINGS

A more particular description of the disclosure briefly described above will be rendered by reference to the appended drawings. Understanding that these drawings only provide information concerning typical embodiments and are not therefore to be considered limiting of its scope, the disclosure will be described and explained with additional specificity and detail through the use of the accompanying drawings.

FIG. 1 is a block diagram of an example system for measuring path-integrated concentrations of a particle-medium mixture (particularly an opaque particle-laden flow) using radar tomography according to some embodiments.

FIG. 2A is an operational diagram of a system for conducting radar interferometric tomography for opaque particle-lade flows, according to some embodiments.

FIG. 2B, FIG. 2C, FIG. 2D, FIG. 2E, FIG. 2F, and FIG. 2G are graphs illustrating processing digital signals output by the ADC in FIG. 2A to generate tomographic reconstructions of reflected electromagnetic signals according to some embodiments.

FIG. 3 is a flow diagram of an example method for processing digital signals output by the ADC in FIG. 2A to generate tomographic reconstructions of reflected electromagnetic signals according to some embodiments.

FIG. 4A and FIG. 4B are operational diagrams illustrating calibration systems for direct optical calibration and direct multi-curtain radar phase calibration, respectively, according to some embodiments.

FIG. 5 is a flow diagram of a method for employing a particle counting algorithm according some embodiments.

FIG. 6 are a series of synthetic images used to calculate a particle counting factor associated with a white noise filed, a low-pass filtered field, a contrast-enhanced field, and a final particle distribution, respectively, according to embodiments.

FIG. 7A and FIG. 7B are images illustrated to compare real particles with synthetic particles, respectively, according to embodiments.

FIG. 8A and FIG. 8B illustrate a pair of X-ray micro-tomography images obtained from XRadia Mirco-XCT-400 and ALS beamline 8.3.2, respectively, demonstrating the improvement in image resolution and sharpness, according to some embodiments.

FIG. 9 is an exemplary processing pipeline that extracts particle size properties from computed tomography (CT) images according to some embodiments.

FIG. 10 is a direct calibration rig including a piston-actuated slot funnel used for calibration of the disclosed radar tomography system according to some embodiments.

FIG. 11 is a conceptual diagram of indirect calibration according to some embodiments.

FIG. 12A is a positional diagram illustrating tomographic measurement using a multi-projection setup from various positions to measure arbitrary density distribution according to at least one embodiment.

FIG. 12B is a positional diagram illustrating tomographic measurement using a single projection setup (e.g., axisymmetric distribution of antennas) to measure arbitrary density distribution according to at least one embodiment.

FIG. 13A, FIG. 13B, and FIG. 13C are operational diagrams illustrating radar tomography architectures, respectively, a) range-resolved with passive reflectors, b) frequency-resolved with active reflectors, and c) angle-resolved with phased array or mechanically-steered, according to various embodiments.

FIG. 14A, FIG. 14B, FIG. 14C, FIG. 14D are simplified schematic diagrams of modulated reflectors, respectively, a) switch-based, b) vibration-based, c) mixed-based, and d) amplifier-based, according to various embodiments.

FIG. 15 is an exemplary amplifier-based, frequency-coded reflector for a radar spoofing attack according to an embodiments.

FIG. 16A and FIG. 16B are a millimeter, switch-based radar reflectors for short-range positioning, according to some embodiments.

FIG. 17 is a block diagram of an example computer system in which embodiments of the present disclosure can operate.

### DETAILED DESCRIPTION

The following description sets forth numerous specific details such as examples of specific systems, components, methods, and so forth, in order to provide a good understanding of various embodiments of the techniques described herein for millimeter-wave (mm-Wave) interferometry for opaque particle-lade flows. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Current approaches to conducting measurements in opaque particle-laden flows are challenged for reasons previously discussed. Some non-intrusive, non-optical diagnostics are applicable to opaque flows. X-ray transmission computed tomography (CT), X-ray diffraction tomography, gamma-ray transmission CT, neutron transmission CT, and positron emission CT, use ionizing radiations to characterize opaque flows with extremely high volume fractions (theoretically up to 100%) at high spatial resolution. However, these non-optical diagnostic approaches suffer from high cost, low temporal resolution, and bring a range of health and safety risks. Other non-ionizing methods include nuclear magnetic resonance (NMR) imaging, ultrasound tomography, microwave tomography, and a set of related electrical tomography methods: capacitance tomography (ECT), resistivity tomography (ERT), and impedance tomography (EIT). These methods typically suffer from high attenuation, low-acquisition frequency, and, with the exception of NMR imaging, have relatively low resolution, e.g., on the order of centimeters. Most of those non-optical diagnostics require the experiment to fit within the instrument, restricting their applicability for fluid-driven experiments or applications within larger areas.

Aspects of the present disclosure address these and other deficiencies of measuring concentraitons within opaque particle-laden flows by using a radar system configured to process reflected electromagnetic signals, which have passed through the opaque particle-landen flow, in a particular way. More spefically, the radar system, or a processing device associated with or coupled to the radar system, conducts a tomographic method to measure the volume fraction in optically opaque multiphase flows that overcomes limitations of existing diagnostics in high particle concentration environments.

Originally developed for studying plume-surface interactions in planetary landing experiments, the disclosed systems and methods are amenable to the study of optically opaque dielectric objects, fluids, or plasmas where optical diagnostics fail due to excessive attenuation. These systems and methods measure path-integrated concentrations at high repetition rate for a range of concentrations at least one order of magnitude higher than optical techniques. Sampling rates of 10-20 kilohertz (kHz) have been achieved, but several megahertz (MHz) are possible (e.g., at least up to 5 MHz) using a dedicated, optimized radar system. In some embodiments, a sensor of the radar system compares favorably in terms of cost, power, size, and mass with conventional non-intrusive particle concentration diagnostics and unlike most of these diagnostics, can be extended to field measurements. In opposition to employing X-ray systems, the disclosed systems and methods do not involve ionizing radiation, which is a significant regulatory and safety benefit.

In various embodiments, for example, a radar system includes at least one antenna positioned opposite from at least one reflector with an area under test therebetween having a particle-medium mixture. In some embodiments, the at least one antenna emits, at a reflector, a series of chirps within a first electromagnetic signal and receives a second electromagnetic signal that includes reflected chirps that bounce off the reflector. An analog-to-digital converter (ADC) can be coupled to the at least one antenna, the ADC to convert the second electromagnetic signal to a digital signal containing phase, frequency, and amplitude information. In doing so, the ADC may sample the second electromagnetic signal at between 10 kHz to at least 5 MHz. A processing device can be coupled to the ADC and configured to process the digital signal to detect raw phase data of reflector peaks to be tracked over the reflected chirps; unwrap the raw phase data into a continuous phase-based signal; correct for phase non-linearities within the continuous phase-based signal; and generate, from the corrected continuous phase-based signal, a path-integrated particle number density for the particle-medium mixture.

In some embodiments, the disclosed system includes a plurality of reflectors and a radar system positioned opposite from the plurality of reflectors with an area under test therebetween having a particle-medium mixture. In at least these embodiments, the radar system includes a plurality of antennas to emit a plurality of chirp signals at the plurality of reflectors and to receive a plurality of electromagnetic signals that include reflected chirps that bounce off of respective ones of the plurality of reflectors. In some embodiments, a mixer circuit is coupled to the plurality of antennas and configured to distinguish the plurality of electromagnetic signals as associated with a particular chirp signal of the plurality of chirp signals. An ADC may be coupled to the mixer circuit, the ADC to convert the plurality of electromagnetic signals to a plurality of digital signals containing phase, frequency, and amplitude information. A processing device can be coupled to the mixer circuit, the processing device to process each digital signal of the plurality of digital signals to: detect raw phase data of reflector peaks to be tracked over the reflected chirps; unwrap the raw phase data into a continuous phase-based signal; correct for phase non-linearities within the continuous phase-based signal; and generate, from the corrected continuous phase-based signal, a path-integrated particle number density for the particle-medium mixture. In some embodiments, the processing device further generates tomographic data indicative of the path-integrated particle number density over a plurality of paths associated with respective antennas of the plurality of antennas.

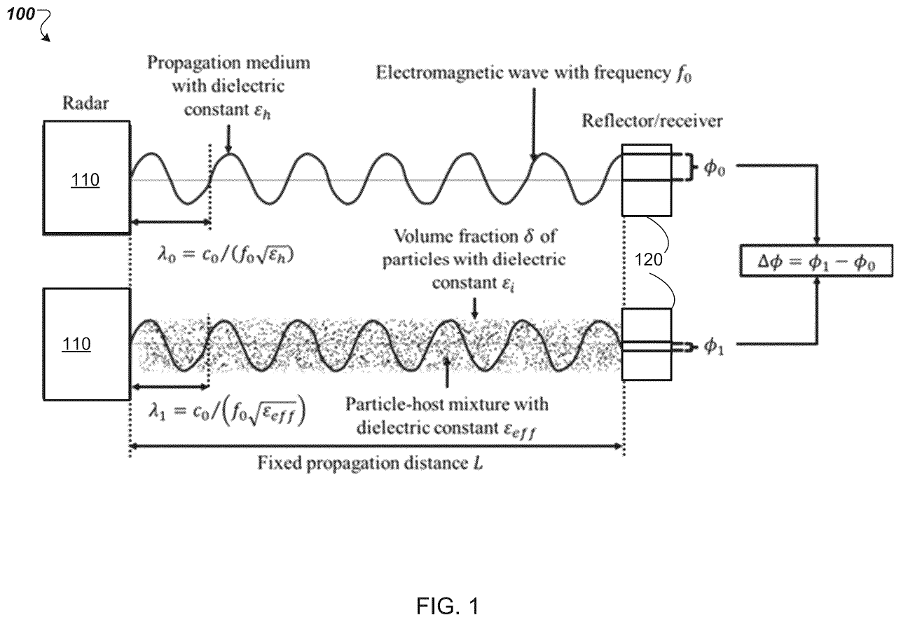

FIG. 1 is a block diagram of an example system 100 for measuring path-integrated concentrations of a particle-medium mixture (particularly an opaque particle-laden flow) using radar tomography according to some embodiments. In some embodiments, the system 100 is designed as a distributed, tomographic imaging instrument operating in the millimeter-wave range for high-speed measurements of the 3D property distribution of optically opaque multiphase flows, although the system 100 is also applicable to solid dielectric objects and to plasmas. In some embodiments, the system 100 includes a radar device 110 positioned opposite to a reflector 120, which also includes a receiver (RX) to detect an electromagnetic wave transmitted by the radar device 110 through a particle-host mixture that may be assumed to be generally opaque to light, and thus not susceptible to optical measurement.

The example application of the disclosed system 100 is the measurement of the concentration of solids in a multiphase gas-particle mixture. An electromagnetic wave of frequency f₀ propagates between the radar device 110 and the reflector 120 (e.g., or an emitter and a receiver, respectively), both located at fixed positions. The time-of-flight of the wave τ depends on the relative permittivity of the propagation medium ε, the propagation distance L and the speed of light in vacuum c₀:

$$τ = {\int }_{L} \frac{\sqrt{ε}}{{c}_{0}} d l \qquad ( 1 )$$

The value of ε can change depending on the local properties of the propagation medium, such as density, humidity, and the presence of multiple material phase as inclusions (droplets, aerosols, particulates, foams). Assuming a modified permittivity ε₁ and a reference permittivity ε₀, we can express the time delay Δτ and phase shift Δϕ due to the change in relative permittivity:

$$Δ τ = \frac{1}{{c}_{0}} {\int }_{L} ( \sqrt{{ε}_{1}} - \sqrt{{ε}_{0}} ) dl \qquad ( 2 )$$

$$Δϕ = \frac{2 π}{{λ}_{0}} {\int }_{L} ( \sqrt{{ε}_{1}} - \sqrt{{ε}_{0}} ) dl \qquad ( 3 )$$

When the change in permittivity is small, it is convenient to express ε₁ in a linearized form:

$${ε}_{1} = {ε}_{0} + Δ ε = {ε}_{0} ( 1 + α ) \qquad ( 4 )$$

with ε₀ and Δε the reference and variable parts of the relative permittivity, respectively, and α=Δε/ε₀<<1, so a is the change in permittivity divided by the reference permittivity. In practice, the assumption of small changes in ε is valid to quantify the effect of electron temperature and densities in plasmas, density and humidity changes in gases, and multiphase mixtures in which the volume fraction δ of inclusions in the medium is small (δ<<1). This condition covers a wide range of potential applications including fusion reactors, foams, aerosols, smoke, liquid sprays, dust clouds, and powders transport. The phase shift Δϕ due to a can also be expressed as a linearized form:

$$Δ ϕ = \frac{2 π}{{λ}_{0}} {\int }_{L} ( \sqrt{{ε}_{1}} - \sqrt{{ε}_{0}} ) dl = \frac{2 π \sqrt{{ε}_{0}}}{{λ}_{0}} {\int }_{L} ( \sqrt{1 + α} - 1 ) dl \approx \frac{π \sqrt{{ε}_{0}}}{{λ}_{0}} {\int }_{L} α dl . \qquad ( 5 )$$

The above equation states that for a small permittivity change a, the phase shift Δϕ of the wave propagating through the medium is linearly proportional to the path integral of a. Therefore, measuring the phase shift Δϕ through an interferometric method gives access to the path integral of a. In the application described in FIG. 1, in which the instrument measures the solid concentration of a gas-particle mixture, an effective medium equation (Maxwell-Garnett, Drude, Bruggeman, etc.) can be used to link a (and therefore Δϕ) to the volume fraction δ of particles. The Maxwell-Garnett equation, for example, provides:

$$α = 3 \frac{{ε}_{i} - {ε}_{0}}{{ε}_{i} + 2 {ε}_{0}} δ \qquad ( 6 )$$

with εᵢ the relative permittivity of the particle material. Different expressions for α can be used depending on the quantity being measured by the instrument (electron temperature and densities in plasmas, gas density, humidity, etc.) and the physical model used. Thus, 3D or 2D property distributions can be reconstructed from multiple path-integrated measurements using tomographic techniques described that will be described.

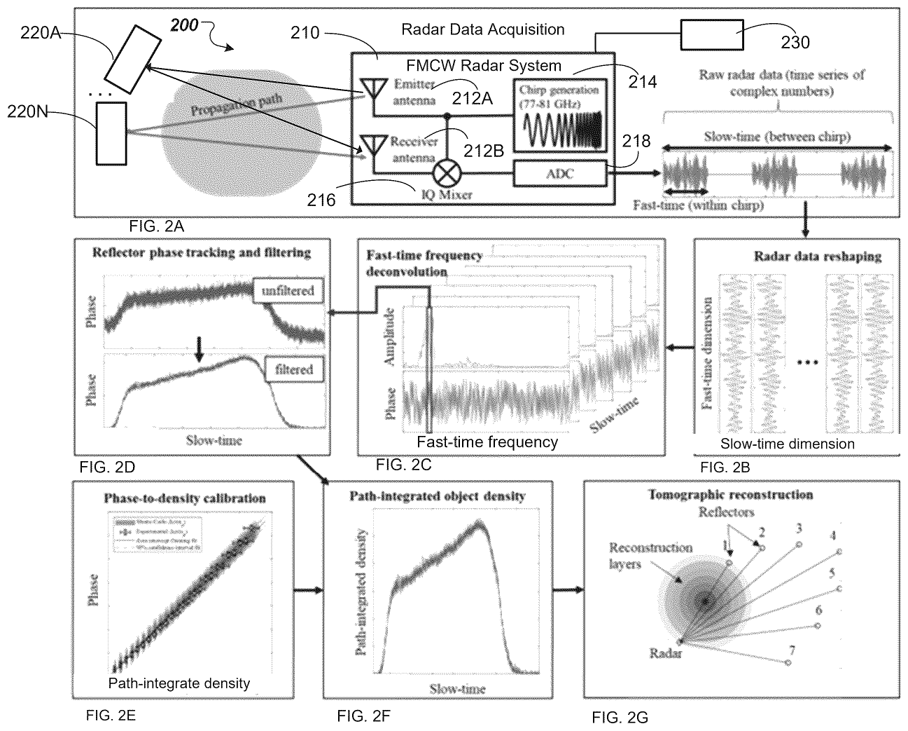

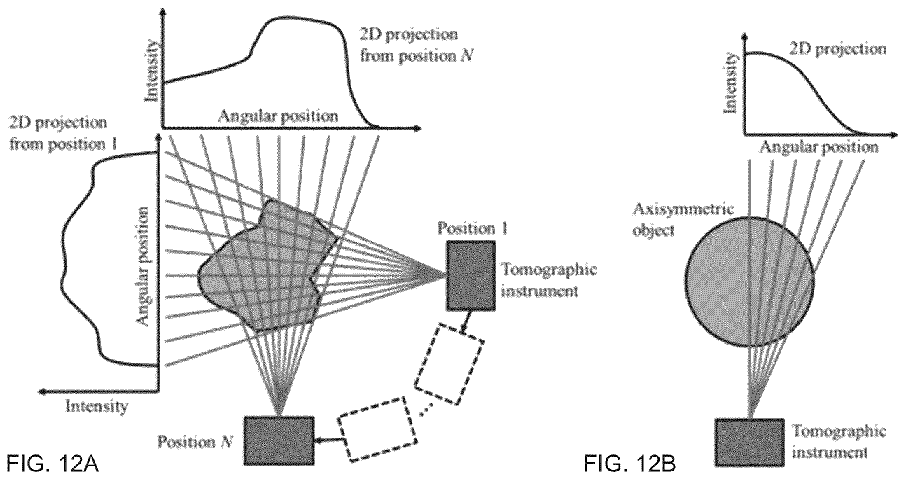

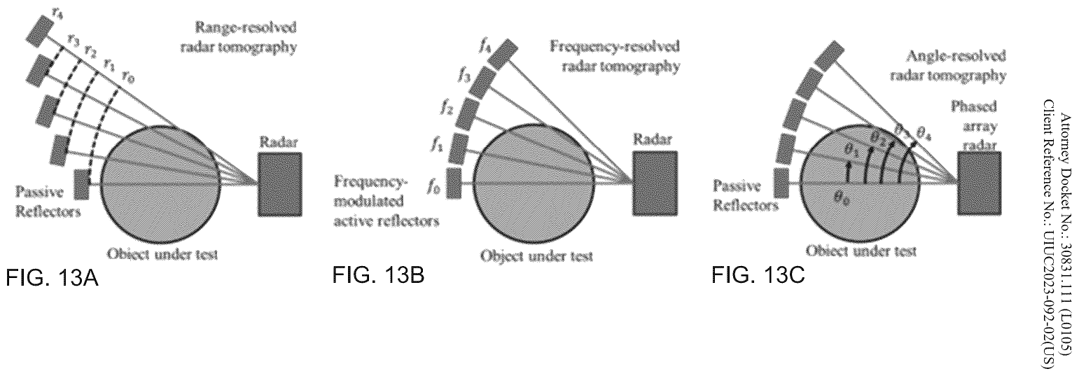

FIG. 2A is an operational diagram of a system 200 (e.g., radar acquisition system) for conducting radar interferometric tomography for opaque particle-lade flows, according to some embodiments. In some embodiments, the system includes a radar system 210, multiple reflectors 220A-220N, and a processing device 230. In some embodiments, the processing device 230 is coupled to the radar system 210. In other embodiments, the processing device 230 is integrated with the radar system 210. Different embodiments for positioning of the multiple reflectors 220A-220N are illustrated and discussed with reference to FIG. 2G, FIGS. 12A-12B, and FIGS. 13A-13C. In at least some embodiments, the reflectors 220A-220N are flat and have fixed positions from which electromagnetic signals (including chirp signals) are reflected.

In various embodiments, the radar system 210 is positioned opposite from the reflectors 220A-220N with an area under test therebetween having a particle-medium mixture. The particle-medium mixture can include at least one of an optically opaque dielectric object, fluid, or plasma. In some embodiments, the radar system 210 is a frequency-modulated continuous-wave (FMCW) radar system and includes one or more antennas 212A and 212B to emit a plurality of chirp signals at the reflectors 220A-220N and to receive a plurality of electromagnetic signals that include reflected chirps that bounce off of respective ones of reflectors 220A-220N. In some embodiments, although the radar system 210 illustrates an emitter antenna 212A and a receiver antenna 212B, the radar system 210 may include a single antenna or antenna array and employ transmit/receive modules to switch between transmit and receive modes.

For example, the radar system 210 may be a phased-array radar system in which the antennas are a phased array of antenna elements. These same antenna elements may be used for both transmitting and receiving. Such systems may employ what are known as Transmit/Receive (T/R) modules where each antenna element in the array may be connected to a T/R module that can switch between transmit and receive modes. This design allows for a compact and efficient array, which is particularly useful in applications where space and weight are critical, such as in aircraft or satellites.

In other designs, especially in larger and more complex radar installations, separate antennas may be used for transmitting and receiving, as illustrated in FIG. 2A. This can be due to various reasons, such as the need for different antenna characteristics for transmitting and receiving, or to avoid interference between the transmit and receive signals.

In at least some embodiments, the radar system 210 includes a chirp generator 214 that generates the chirp signals referred to previously, e.g., in a millimeter wave ranges. In some embodiments, the millimeter wave range is between approximately 77-81 gigahertz (GHz) and over a time period of tens of microseconds. In some embodiments, this time period is between approximately 40-60 microseconds, e.g., may be about 50 microseconds. In other embodiments, the chirp signals are emitted anywhere within the microwave range of frequencies and over tens of nanoseconds to thousands of microseconds. In some embodiments, the radar system 210 includes a transceiver coupled to the one or more antennas 212A and 212B and configured to cause the series of chirps to be emitted within a microwave range of frequencies and over a time period of tens of nanoseconds to thousands of microseconds.

In at least some embodiments, the radar system 210 includes a mixer circuit 216 (e.g., an IQ mixer) coupled to the antennas 212A and 212B. In some embodiments, the mixer circuit 216 distinguishes the plurality of electromagnetic signals as associated with a particular chirp signal of the plurality of chirp signals. In some simpler designs with a single transmit antenna and a geographically simple area under test, the mixer circuit 216 may be unnecessary and can optionally be omitted.

In embodiments, the radar system 210 includes an ADC 218 coupled to the mixer circuit 216, the ADC 218 to convert the plurality of electromagnetic signals to a plurality of digital signals containing phase, frequency, and amplitude information. In performing experimentation, the specific model of radar system 210 (or device) used was the IWR1443BOOST by Texas Instrument, but the methods disclosed herein are applicable to any FMCW-coherent radar. In embodiments, the ADC 218 converts a reflective electromagnetic signal received from one or more reflectors 220A-220N to a digital signal containing phase, frequency, and amplitude information. In some embodiments, an FMCW radar may be used as the active part of the radar data acquisition system 200 (or instrument) to discriminate between the reflector echo and unrelated reflections from other parts of the area-under-test (clutter) without requiring the complex quasi-optical beam-forming system of continuous-wave interferometers.

As a summary, a first operation of the disclosed signal acquisition and processing technique can be the acquisition of the raw radar signal (or raw radar data), which discussed with reference to FIG. 2A. The radar system 210 (e.g., FMCW radar system) can emit a series of linear frequency ramps repeating at fixed intervals, e.g., which may be generally referred to as chirps. Thus, signals made up of chirps may be referred to as chirp signals. In the disclosed experiments, the chirp ramps were between 77 and 81 GHz over a period of 50 microseconds, but different millimeter wave frequencies and varying time periods are envisioned, as was discussed. The chirp travels through the area-under-test, bounces on the reflector(s), and is then received by the radar.

In some embodiments, the mixer circuit 216 mixes the received chirp with the currently emitted chirp, where the propagation delay between the two signals gives rise to a beat frequency, which is captured by the ADC 218. The frequency of the beat signal is directly proportional to the distance of the reflector 220A, while its phase provides access to sub-period variations in propagation time. Sub-period variations in propagation time are either due to small movements of the reflector relative to the radar (e.g., vibrations), or due to changes in dielectric constants on the propagation path. In the disclosed application of the system 200, dielectric constant variations are of interest, while vibrations are unwanted.

The scene illuminated by the radar system 210 does not consist of a single point reflector, but can be understood to be a complicated number of scatterers of various size, distance, and reflective properties. Consequently, the signal captured by the ADC 218 is not a single tone, but rather a complicated waveform resulting from the sum of all the scatterers' responses, from which the reflector echo can be isolated. Note that the ADC signal is a complex time series with an in-phase and quadrature component, therefore containing phase, frequency, and amplitude information.

FIG. 2B, FIG. 2C, FIG. 2D, FIG. 2E, FIG. 2F, and FIG. 2G are graphs illustrating processing digital signals output by the ADC in FIG. 2A to generate tomographic reconstructions of reflected electromagnetic signals according to some embodiments. In some embodiments, the processing device 230 is coupled to the ADC 218 and configured to process each digital signal of the plurality of digital signals, as discussed in more detail now with reference to FIGS. 2B-2G.

In some embodiments, a second operation of the disclosed technique includes reshaping the raw radar data into a two-dimensional (2D) array, as illustrated in FIG. 2B. The fast-time axis represents the sampling inside each chirp, while the slow-time axis represents the sampling between the chirps. For example, a one-second-long series of 50 microsecond chirp acquired at a 5 MHz sampling rate will result in a 2D array (e.g., 2D square) with 250 rows of fast-time data and 20,000 columns of slow-time data. If the radar has multiple emitters and/or receivers, the antenna space may also add another dimension to the data array.

In some embodiments, a third operation of the disclosed technique includes applying a fast Fourier transform (FFT) to the fast-time dimension of the 2D data array, as illustrated in FIG. 2C, although additional convolution techniques are envisioned, to include a chirplet transform, wavelet transform, Gabor transform, Hilbert transform, Hadamard transform, Z-transform, Laplace transform, or a combination thereof. This process allows the conversion each chirp from the time domain to the frequency domain, with each frequency contained in the signal visible as a peak in the Fourier or converted spectrum. Because of the FMCW mode of operation, those peaks correspond to discrete objects illuminated by the radar, with a range proportional to the frequency of the peak. If the radar has multiple emitters and/or receivers, another FFT can be performed along the antenna array dimension, providing an angle-of-arrival (AoA) detection capability. Thus, in some embodiments, the antennas 212A and 212B include an antenna array. In some embodiments, the processing device 230 applies the FFT (or, more generally, converts spatial data to the frequency domain) also along a dimension of the antenna array to generate an angle-of-arrival (AoA) detection of the reflected chirps and determines a range-angle spectrum using AoA-based information.

The known range (and angle-of-arrival) of the reflector allows the corresponding reflector signal to be identified in the range (or range-angle) spectrum. This, in turn, allows the phase of the reflector peak to be tracked over all chirps, as illustrated in FIG. 2D. This raw phase track may be unwrapped (meaning that the 2π-discontinuities or “wraps” in the phase can be removed to reveal its true continuous value), filtered, and corrected for hysteresis, thermal drift, and negative phase.

In some embodiments, the corrected phase is converted to a path-integrated density, as illustrated in FIG. 2F, either using a theoretically derived equation or an experimental calibration curve, as illustrated in FIG. 2E. Finally, the path-integrated densities of several reflector positions may be combined and a local density distribution derived using an axisymmetric tomographic reconstruction technique, as illustrated in FIG. 2G.

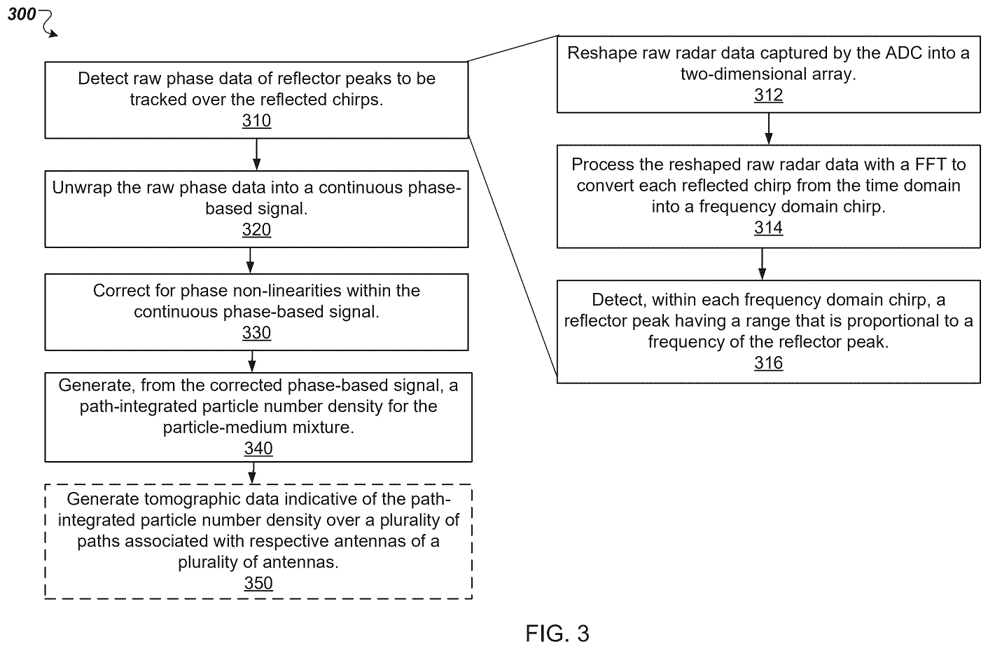

FIG. 3 is a flow diagram of an example method 300 for processing digital signals output by the ADC in FIG. 2A to generate tomographic reconstructions of reflected electromagnetic signals according to some embodiments. The method 300 may be performed by processing logic that may comprise hardware (e.g., circuitry, dedicated logic, programmable logic, microcode, etc.), software (such as instructions running on the processor), firmware or a combination thereof. In one embodiment, at least aspects of the disclosed system 200 of FIG. 2 runs on one or more computing device (such as the computer system 1700 of FIG. 17) in order to perform the method 300. In some embodiments the operations of the method 300 may be performed for each identified electromagnetic signal, so may be repeated for multiple reflected electromagnetic signals received from multiple reflectors, e.g., as may be performed by a phase-array architecture.

At operation 310, the processing logic detect raw phase data of reflector peaks to be tracked over the reflected chirps. In some embodiments, the detecting and tracking of reflector peaks may be performed as set forth in operations 312 through 316.

For example, at operation 312, the processing logic reshapes raw radar data captured by the ADC into a two-dimensional array.

At operation 314, the processing logic processes the reshaped raw radar data with a convolution technique to convert time domain data to the frequency domain. In embodiments, the processing logic employs Fast Fourier Transform (FFT) to convert each reflected chirp from the time domain into a frequency domain chirp, although additional convolution techniques are envisioned, to include a chirplet transform, wavelet transform, Gabor transform, Hilbert transform, Z-transform, Laplace transform, or a combination thereof.

At operation 316, the processing logic detects, within each frequency domain chirp, a reflector peak having a range that is proportional to a frequency of the reflector peak.

At operation 320, the processing logic unwraps the raw phase data into a continuous phase-based signal.

At operation 330, the processing logic corrects for phase non-linearities within the continuous phase-based signal.

At operation 340, the processing logic generates, from the corrected continuous phase-based signal, a path-integrated particle number density for the particle-medium mixture.

At operation 350, the processing logic generates tomographic data indicative of the path-integrated particle number density over one or more paths associated with one or more antennas of a plurality of antennas of the radar system.

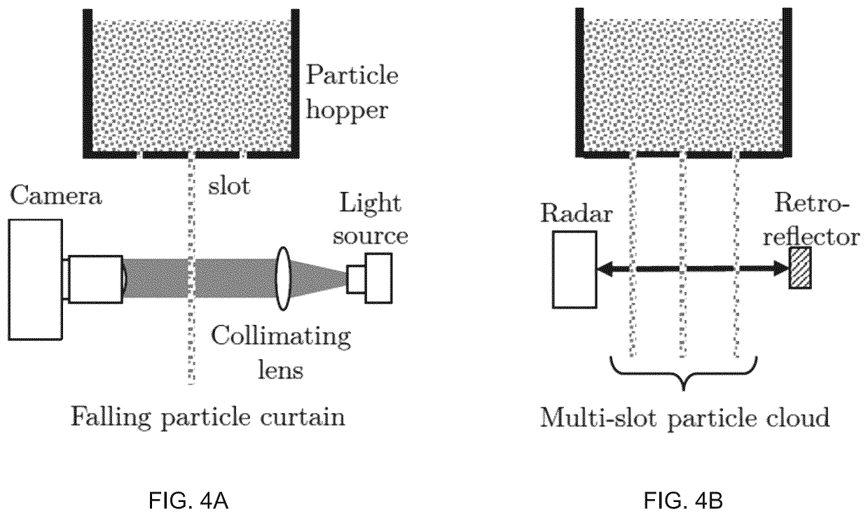

FIG. 4A and FIG. 4B are operational diagrams illustrating calibration systems for direct optical calibration and direct multi-curtain radar phase calibration, respectively, according to some embodiments. The theoretical framework presented earlier discusses a linear relationship between the phase shift measured by the system 200 and the path-integrated concentration. The constant of proportionality depends on the operating frequency, host medium, and dispersed phase properties. Provided this relationship holds approximately precise, for a given radar, it would suffice to know accurately the dielectric constants of the host medium and particles. This can serve as the basis for an indirect calibration method, which utilizes a custom interference-based technique to measure the relative permittivity of a bulk powder at millimeter wave frequencies, as will be discussed in more detail. However, several simplifying assumptions are involved in effective medium theories which may render inaccurate the proportionality factor or even the linear relation. A direct calibration method, therefore, uses known particle concentrations and can therefore account for potential deviations from effective medium theory. Both techniques may avoid needing a mm-Wave Vector Network Analyzer (VNA), an expensive and very specific instrument that is not widely available.

In some embodiments, the direct calibration process is based on the superposition of thin curtains of falling particles, each of which can be individually characterized using an optical counting method. When combined, the curtains provide an optically-thick medium with a known path-integrated particle concentration within the measurement range of the radar system 210. Using this direct calibration procedure, the system 200 measures the travel delay through the same mass of air, laden and unladen, at an interval of a few seconds, which also eliminates any variability due to the host medium. This is in contrast with solid matrix calibration methods, which require tight control on the matrix dimensions and physical properties as they directly influence the propagation time of the waves through the mixture.

In some embodiments, the direct calibration was implemented using a funnel with individually addressable slots to generate thin curtains of falling particles. The path-integrated concentration of each curtain was measured by a shadow graphic optical particle-counting method illustrated in FIG. 4A. Once the particle curtains generated by each slot were characterized, a particle cloud with a known path-integrated concentration was generated by simultaneously opening multiple slots, as illustrated in FIG. 4B. By measuring the phase shift for an increasing number of open slots, a calibration curve for phase shift as a function of particle number concentration is obtained. The direct calibration set-up covered up to 15% of the unambiguous (0-360°) measurement range of the system 200. The relationship between these parameters is assumed to remain linear, e.g., the direct calibration can be extrapolated to higher concentrations.

The direction calibration set-up employs a funnel with nₛₗₒₜ=25 slots, each individually generating a thin curtain of falling particles that can be inhibited by a lid. A sliding trapdoor, actuated by a pneumatic piston, is used to open all active slots simultaneously. Opening multiple slots combines individual curtains into a larger particle cloud used to calibrate the interferometer. The thickness (e.g., ˜ 1 mm) and concentration of each curtain is sufficiently low to measure its path-integrated concentration using optical imaging. A ThorLabs 1.5 W MCWHL8 white LED light source combined with a spherical lens provide uniform lighting perpendicular to the thin particle curtain, allowing high-resolution shadowgraphy using a Chronos 1.4 camera equipped with a Canon EF 100 mm macro lens. The output images have a magnification of 13.3 μm/pixel, resolving particles with an average diameter of 103 μm with 48 pixels.

Optical particle counting provides the projected number concentration of particles (∫Nᵢ dl) in the curtain, which can be converted to the projected volume fraction (∫δᵢ dl):

$$\int {δ}_{i} dl = \frac{π}{6} {\int }_{0}^{+ ∞} {D}^{3} P ( D ) dD \int {N}_{i} dl = \frac{π}{6} {D}_{[ 3 , 0 ]}^{3} \int {N}_{i} dl \qquad ( 7 )$$

where P (D) is the size distribution and D [3,0] is the volume mean diameter of the particles. The direct calibration relies on the superposition of individually characterized particle curtains, thus requiring the projected concentration of a multi-slot cloud (∫N_{cloud} dl) to be the sum of the projected concentrations of each of its component slots, Equation (8). This is ensured by performing the calibration in a vacuum chamber with a reduced atmosphere at 130 Pa, preventing particle-drag induced airflow which would lead to inter-curtain particle interactions. By varying nslot,open=Σ si, we obtain a set of known projected number concentrations {∫Nk dl} k. By measuring the phase of the radar signal before and after the slots are opened, we obtain the corresponding set {Δϕk}k needed to calculate the direct calibration curve of the instrument.

$$\int {N}_{c l o u d} dl = {\sum }_{i = 1}^{{n}_{s l o t}} {s}_{i} \int {N}_{i} dl with {s}_{i} \{ \begin{matrix}1 if slot i is open \\ 0 if slot i is closed\end{matrix} \qquad ( 8 )$$

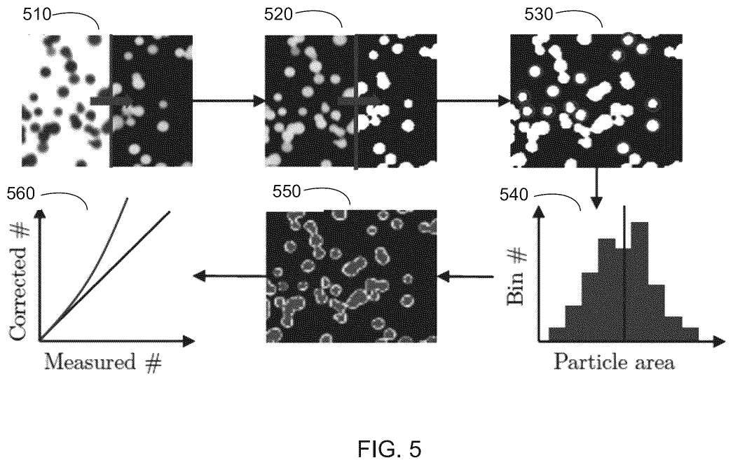

FIG. 5 is a flow diagram of a method 500 for employing the above-referenced particle counting algorithm according some embodiments. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the computing system 1700 of FIG. 17. The operations of the method 500 can be performed in an order other than that specifically illustrated.

Particle clustering and overlapping can be accounted for to accurately measure the projected particle number concentration on each individual thin curtain. A naive segmentation-based counting procedure can count a cluster of multiple particles as a single, large particle, underestimating the real particle concentration.

At operation 510, the processing logic performs preprocessing. The particle images are inverted, background-subtracted, and contrast enhanced.

At operation 520, the processing logic binarizes the images.

At operation 530, the processing logic segments the binarized images. Isolated, non-clustered particles are identified using a roundness threshold.

At operation 540, the processing logic calculates the mean area of non-clustered particles.

At operation 550, the processing logic divides the total apparent area of particles by the single particle mean area to obtain an uncorrected number of particles.

At operation 560, the processing logic applies a correction factor to the uncorrected number of particles to account for particle overlapping in clusters, leading to the corrected number of particles.

In some embodiments, the processing logic calculates the correction factor used in operation 560 using synthetic images representative of preprocessed images of real particles. The synthetic images are generated with a known number of particles randomly distributed in the image, with a size distribution matching that of the real particles. By processing the synthetic images in the same way as the real images (e.g., operations 520 to 550) of the above particle counting procedure and fitting the measured number of particles to the real number of particles, the correction factor can be calculated. The counts obtained with the method 500 can be validated by comparing to counts provided by a machine learning tool associated with a density model. The counting model can be trained on a randomly selected video frame in which particles were manually labeled. The model then processed the entire 75000 frames dataset.

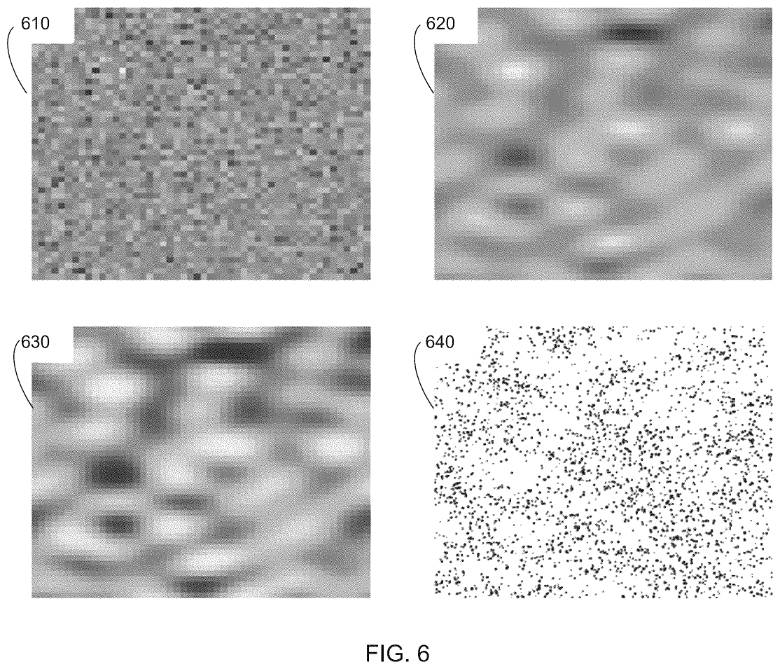

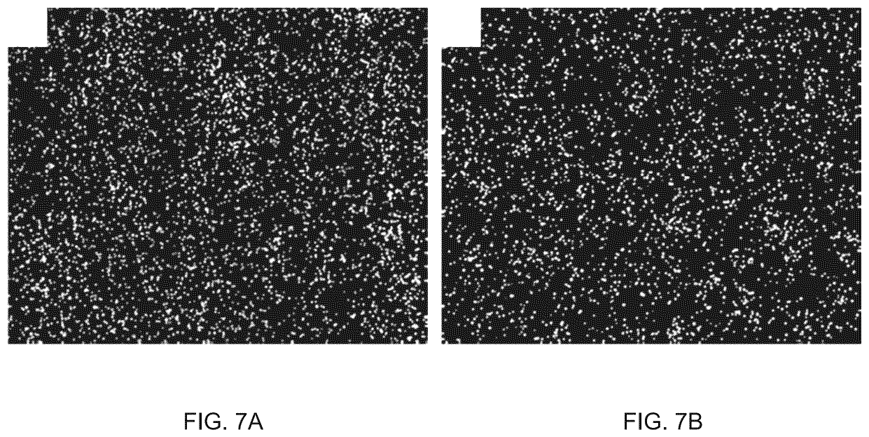

The procedure used to generate synthetic images representative of real particle images with clustering and non-uniform particle distribution is presented in FIG. 6. At operation 610, the processing logic generates synthetic images representative of real particle images with clustering and non-uniform particle distribution is to generate a 2D white noise field, which serves as a distribution function for the particle positions. At operation 620, the processing logic applies a low-pass filter to the noise field, where the loss-pass filter includes a cut-off frequency f_{c} corresponding to the minimum cluster size desired 1/fc. Then, at operation 630, the processing logic uses a sigmoid function with scaling parameter lₛ to control the particle gradients in the distribution: a low value of lₛ creates sharp contrasts between low and high concentration regions, while a large value of lₛ creates smooth concentrations contrasts. Finally, at operation 640, the processing logic employs rejection sampling on the distribution to generate np particle position in the final image. The parameters fc, lₛ, np are themselves uniformly sampled across an interval of interest to generate a dataset of 1000 synthetic images on which the correction factor is fitted. A visual comparison between a real and a synthetic image is presented in FIG. 7A and FIG. 7B.

In embodiments, the particle size distribution (PSD) P(D) defines the normalized abundance of particles with a diameter D in a sample. The generalized mean of P(D) can be defined as expressed in Equation (9).

$${D}_{[ j , k ]} = {( \frac{{\int }_{0}^{+ ∞} {D}^{j} P ( D ) dD}{{\int }_{0}^{+ ∞} {D}^{k} P ( D ) dD} )}^{\frac{1}{j − k}} \qquad ( 9 )$$

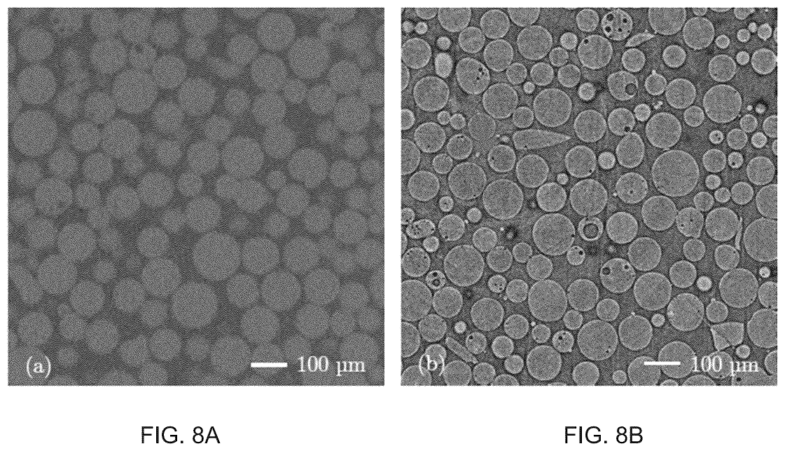

The volume mean diameter D [3,0] can used to convert between number concentration (j) and volume concentration (k). We use X-ray micro-tomography to measure P(D) accurately. Prior measurements had a scan spatial resolution of 2.61 μm/pixel. In this disclosure, the uncertainty on our measurement of P(D) and D [3,0] can be reduced by using CT scans with a higher resolution, e.g., 1.605 μm/pixel, and higher sharpness. The scans were acquired at the beamline 8.3.2 of the Advanced Light Source (ALS) at Lawrence Berkeley National Laboratory. A comparison of images obtained with the previous XRadia MicroXCT-400 and the ALS beamline is presented in FIG. 8. To further verify our measurements, we scanned a calibration standard of monodisperse glass microspheres with a mean diameter of 150±9 μm manufactured by the Mo-Sci corporation.

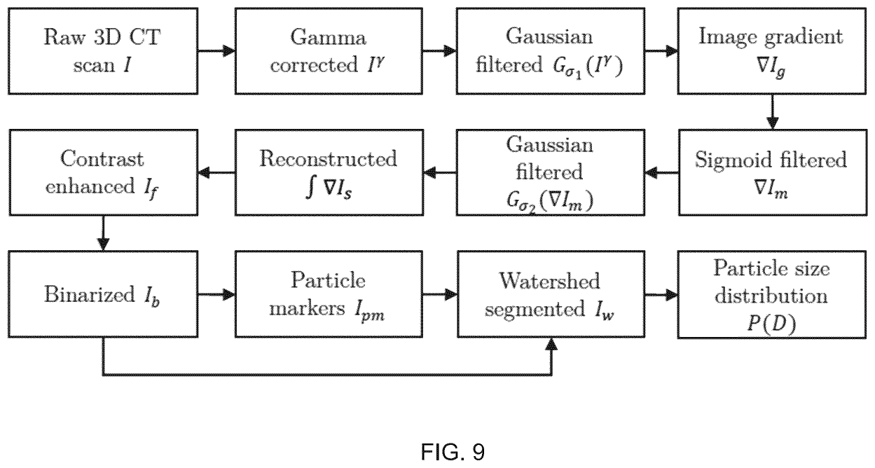

FIG. 9 is an exemplary processing pipeline that extracts particle size properties from computed tomography (CT) images according to some embodiments. Accordingly, the raw CT scans were processed according to the pipeline shown in FIG. 9. The CT scans of particles are filtered, binarized, and segmented using a watershed algorithm implemented in MATLAB, resulting in a set of labeled particles whose diameter is measured and binned to determine P(D). We use an edge-preserving smoothing filter to eliminate noise while keeping particles edges sharp. This filter operates in several stages. First, the input image l undergoes pre-processing with gamma correction and Gaussian smoothing, as shown in Equation (10).

$${I}_{g} = {G}_{σ} ( {I}^{γ} ) \qquad ( 10 )$$

where Ig is the preprocessed image, Gσ represents a Gaussian filter with standard deviation σ, and γ is the gamma correction factor. Next, we compute the gradients of this preprocessed image as in Equation (11).

$$∇ {I}_{g} = ( \frac{\partial {I}_{g}}{\partial x} , \frac{\partial {I}_{g}}{\partial y} ) \qquad ( 11 )$$

These gradients can then be modulated using a sigmoid function, as expressed in Equation (12).

$$Δ {I}_{m} = \frac{∇ {I}_{g}}{1 + {e}^{α ( β - \vert ∇ {I}_{g} \vert )}} \qquad ( 12 )$$

where α and β are parameters controlling the shape of the sigmoid function. This operation can crush low-amplitude gradients associated with noise while leaving large-amplitude gradients associated with particle edges intact. The modulated gradients can then be smoothed as expressed in Equation (13), with γ being the standard deviation for this Gaussian smoothing.

$$∇ {I}_{s} = {G}_{γ} ( ∇ {I}_{m} ) \qquad ( 13 )$$

The image can then be reconstructed from these processed gradients as expressed in Equation (14).

$${I}_{r} = \int ∇ {I}_{s} \qquad ( 14 )$$

Finally, the local contrast can be enhanced by subtracting a large-scale Gaussian filtered version of the reconstructed image, as expressed in Equation (15), where I_{f} is the final filtered image, and G_{σ}_{ᵢ} is a Gaussian filter with a large standard deviation σ₁.

$${I}_{f} = {I}_{r} - {G}_{{σ}_{l}} ( {I}_{r} ) \qquad ( 15 )$$

This process results in an edge-preserved smoothed image with enhanced local contrast. In embodiments, I_{f} is then converted into a binary image I_{b}, with particle material in white and voids in black. This allows us to measure the solid fraction of the bulk particles δ_{bulk}, as the fraction of white of pixel over the total scanned volume. δ_{bulk} is used to calculate the relative permittivity measurement according to the procedure presented previously. X-ray micro-CT is not the only way to measure δ_{bulk}, nor is it the simplest: helium pycnometry is the standard method for measuring solid fraction in powder samples. However, micro-CT is needed in this study for the direct calibration procedure to accurately measure P (D), and δ_{bulk} is a convenient byproduct of the particle segmentation process.

Experimenters interested in taking full advantage of the particle-size agnostic nature of millimeter wave interferometry are encouraged to use helium pycnometry for measuring δ_{bulk} as part of their indirect calibration process. Of course, when a non-powder sample of the particle material of interest is available (solid or liquid), δ_{bulk} is unnecessary, as the relative permittivity of the material can be measured directly without needing an effective medium equation.

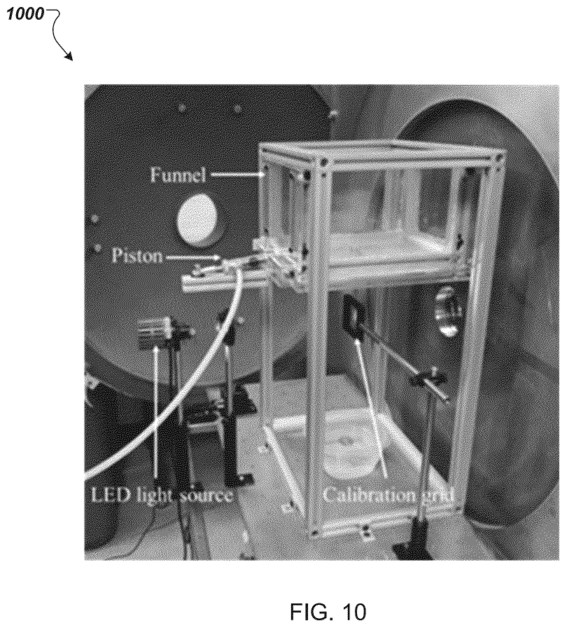

FIG. 10 is a direct calibration rig 1000 including a piston-actuated slot funnel used for calibration of the disclosed radar tomography system according to some embodiments. In at least some embodiments, the direct calibration methodology employs particle curtains that are identical when individually or jointly operated, which is not the case in ambient conditions due to aerodynamic entrainment, e.g., the interaction between particle curtains due to viscous drag. The interaction between the gravity-driven particle flow and the otherwise quiescent surrounding air may lead to the generation of a turbulent flow. When multiple particle streams in close proximity are operated, the cross-section of a given stream, particle velocities and thus local particle concentration are modified, leading to a path-averaged concentration that is different from the sum of the contributions of each individual curtain. To avoid these undesired effects, the direct calibration was performed in a vacuum chamber of the calibration rig 1000 in a reduced atmosphere at 130 Pascal (Pa). The custom-made direct calibration rig 1000, as installed in the vacuum chamber, is illustrated in FIG. 10. The direct calibration rig 1000 includes a funnel assembly containing a particle hopper, a sliding trapdoor, and an array of 25 individually-addressable slots, each with a width of 600 μm, a length of 140 mm, and a spacing of 9.525 mm between the center of each slot. The sliding trapdoor was remotely actuated by a pneumatic piston.

In some embodiments, a 1.5 watt (W) white LED collimated by a biconvex lens with a focal length of 100 mm provided the back-illumination for the shadowgraph particle counting. A 1.3 Megapixel Chronos 1.4 high-speed camera equipped with a Canon EF 100 mm macro lens was used for imaging the particle stream at 1057 frames per second. An exposure of 5 microseconds was used to prevent motion blur of the falling particles.

The following procedure was used to count the particles. First, images were segmented from the background and a sample of well-resolved single particles was selected using a combination of size and roundness thresholds. The total area of all particles in the image was then divided by the average particle area of the selected sample, and a correction factor was applied to account for overlapping. The correction factor was derived by comparing the number of particles counted by the pipeline against synthetic images with a known number of particles. The synthetic images used are representative of real background-subtracted images, with dark circular particles against a white background.

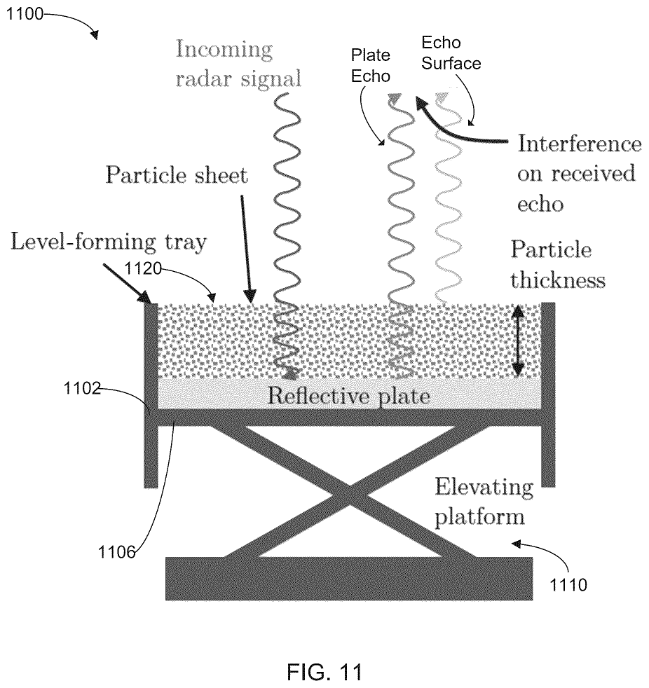

FIG. 11 is a conceptual diagram of indirect calibration according to some embodiments. To perform the indirect calibration, a test fixture 1100 can be employed that includes a fixed frame 1102, a reflective plate 1106, and an elevating platform 1110. The reflective plate 1106 is mounted on the elevating platform 1110, which can move up and down inside of the frame 1102, forming a variable-depth tray 1120 that can be filled with particles. A radar can be fixed on a vertical post assembly looking downward at the test fixture (not illustrated). During the experiment, the reflective plate 1106 can be gradually raised and excess particles can be removed from the variable-depth tray 1120 to create a progressively thinner layer of particles above the reflective plate 1106. The radar can track the phase and amplitude of the tray echo. A granular layer of the particles can create destructive interference with that of the reflective plate 1106 when a thickness of the particle volume is an odd multiple of

$$\frac{{λ}_{0}}{4 \sqrt{{ε}_{b u l k}}} ,$$

where ε_{bulk} is the relative permittivity of the bulk particle layer including inter-particle voids. The interference can manifest as a drop in amplitude which recurs with a period Δϕ_{tray}=2π\sqrt{ε_{bulk}}. Therefore, measuring the number of destructive interferences at various phases can be used to calculate ε_{bulk} as ε_{bulk}=4π²/(ϕₖ−ϕ₁)².

FIG. 12A is a positional diagram illustrating tomographic measurement using a multi-projection setup from various positions to measure arbitrary density distribution according to at least one embodiment. FIG. 12B is a positional diagram illustrating tomographic measurement using a single projection setup (e.g., axisymmetric distribution of antennas) to measure arbitrary density distribution according to at least one embodiment.

Possible variations in the tomographic technique used in the instrument are presented in FIGS. 12A-12B. Tomography, in this context, refers to a set of techniques that reconstruct the 3-dimensional (3D) density distribution of an object from measurements made using electromagnetic waves transmitted through the object. For an object of arbitrary density distribution, as shown in FIG. 12A, the radar system 210 may acquire many transmission measurements over multiple positions around the object. Applicable tomographic reconstruction techniques include filtered back projection, inverse radon transform, and other iterative methods. In the case of an axisymmetric object, a projection measurement from a single position may be employed to reconstruct the density distribution. An Abel-transform method can be used, such as the onion-peeling algorithm, basis-set expansion (BASEX), or the Daun algorithm.

In some embodiments, and in particular experimentations, employ a single radar system or device in a fixed position, in conjunction with 7 reflectors, to measure a projected strip of the object under test. In embodiments, these measurements are used to reconstruct an axisymmetric density distribution using the Daun algorithm implementation in the PyAbel python package. Extension to non-axisymmetric density distributions may require either multiple radar systems working in parallel or rotating the radar system around the object.

FIG. 13A, FIG. 13B, and FIG. 13C are operational diagrams illustrating radar tomography architectures, respectively, a) range-resolved with passive reflectors, b) frequency-resolved with active reflectors, and c) angle-resolved with phased array or mechanically-steered, according to various embodiments. Thus, FIGS. 13A-13C illustrate possible variations of the radar-reflector architecture of a tomographic system. In telecommunication engineering terms, the reflector architecture is a multiplexing problem: the signal coming from every reflector can be isolated during processing. Three classes of architecture have been identified: passive range-resolved, passive angle-resolved, and active modulated, either in phase, frequency, or amplitude.

Passive reflectors may be simple metallic plates or some variant of a retro-reflective geometry: cube corner, cat's eye, Van Atta array, etc. Thus, passive reflectors can reflect the signal emitted by the radar without any modification. Consequently, passive reflectors generally present a large radar-cross section, and are located sufficiently far apart from each other (in terms of range, or angle of arrival, or both) to be distinguished by the radar system 200.

In some embodiments, with reference to FIG. 13A, the multiple reflectors 220A-220N (FIG. 2A) are passive reflectors, where each carrier frequency is controlled by a distance to a corresponding passive reflector. In these embodiments, the processing device 230 is configured to process the plurality of digital signals to generate range-resolved tomographic data. In other embodiments, with reference to FIG. 13C, the multiple reflectors 220A-220N (FIG. 2A) are passive reflectors located equidistant from the radar system 210, which is one of phased-arrayed or mechanically-steered. In these embodiments, the processing device 230 is configured to process the plurality of digital signals to generate angle-resolved tomographic data.

For a range-resolved system (see FIG. 13A), the minimum separation distance between reflectors depends on the range resolution of the radar. For a system with a few GHz of bandwidth, as used in the current implementation, the minimum separation distance may be of the order of several inches, which renders the use of more than a dozen or so reflectors in range-resolved mode impractical. In telecommunication engineering terms, this method is a form of frequency-division multiplexing (FDM), in which each carrier frequency is controlled by the reflector distance.

In some embodiments, angle-resolved tomography (see FIG. 13C) is a form of space-division multiplexing (SDM). In embodiments, angle-resolved tomography employs a mechanically-steered radar or a phased-array system to provide angle-of-arrival detection capability. The number of active reflectors may be limited by the angular resolution of the radar, which is set by the aperture of the antenna system used. A phased-array system with N TX-RX pairs may have an angular resolution of 360/(πN) degrees. Both angle and range resolution can be combined to increase the number of concurrently-visible reflectors.

In some embodiments, active reflectors allow the radar to differentiate between the signals coming from reflectors in close physical proximity to each other. Therefore, active reflectors allow the design of a reflector array with tens or hundreds of reflectors, vastly improving the resolution of the system 200. Active reflectors may use traditional multiplexing methods applied to the FMCW radar waveforms.

In at least some embodiments, the multiple reflectors (FIG. 2A) are modulated active reflectors located equidistant from the radar system 210. In some embodiments, the processing device 230 is configured to process the plurality of digital signals to generate frequency-resolved tomographic data. The modulated active reflectors may be one of switched-based, vibration-based, mixer-based, or amplifier-based reflectors, for example.

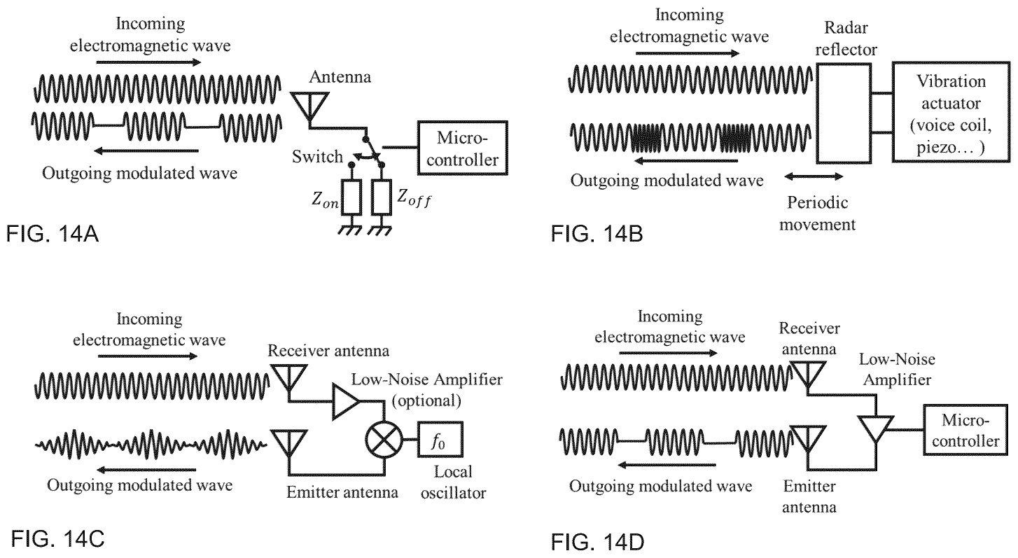

FIG. 14A, FIG. 14B, FIG. 14C, FIG. 14D are simplified schematic diagrams of modulated reflectors, respectively, a) switch-based, b) vibration-based, c) mixed-based, and d) amplifier-based, according to various embodiments. The reflectors themselves can be implemented in two different ways: as a radiofrequency (RF) circuit or as an actuated reflector.

In various embodiments, actuated reflectors rely on the displacement of a conventional metallic reflector to encode a unique identifier for this reflector in the radar signal. This can be accomplished in at least two ways: by vibrating the reflector at a specific frequency, or by shifting the reflector position by half a wavelength between chirps in a Hadamard code, without limitation. In vibration mode, the radar system 210 (e.g., the mixer 216) can separate the signal from each reflector according to its corresponding Doppler shift, which is a form of frequency division multiplexing (FDM). This concept is illustrated in FIG. 14B. Half-wavelength keying is a form of binary phase shift keying (BPSK), for which many demodulation techniques are applicable. Both vibration and half-wavelength encoding are slow-time techniques, which may employ processing of multiple consecutive chirps with a corresponding reduction in measurement rate compared to the nominal pulse repetition rate (PRF) of the radar system 210.

In some embodiments, RF active reflectors acquire the radar signal using one or more antennas, modulate, amplify, and send the processed amplified signal back to the radar system 210. In embodiments, this modulation acts as an ID tag, which may allow the radar system 210 to identify the signal coming from each reflector. Applicable modulation methods include time-division multiplexing (TDM), binary phase shift keying (BPSK) and frequency-division multiplexing (FDM). RF reflectors in FDM mode can achieve a larger bandwidth (10 s of MHz) than other modulation techniques, allowing access to the fast-time (range) space of the radar data, which can greatly increase the number of concurrently active reflectors.

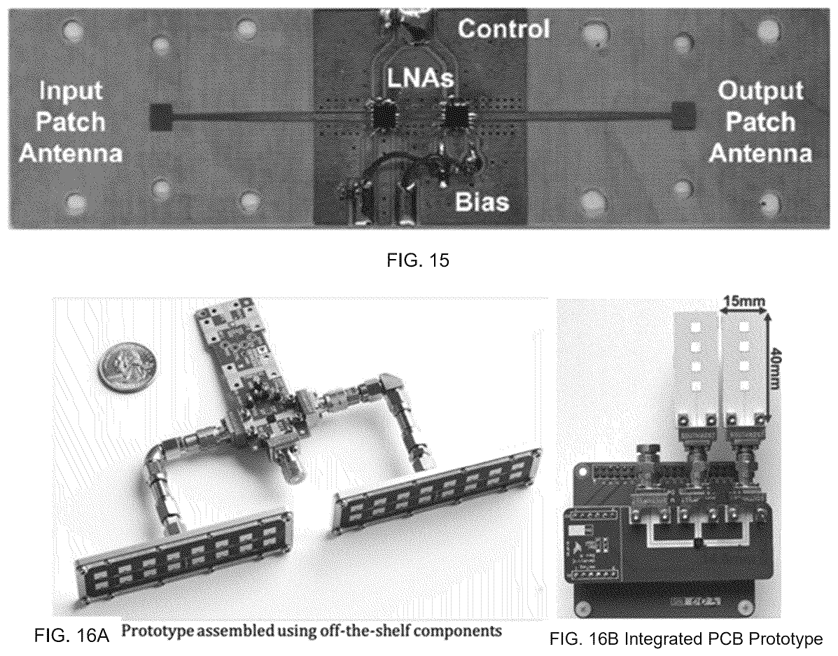

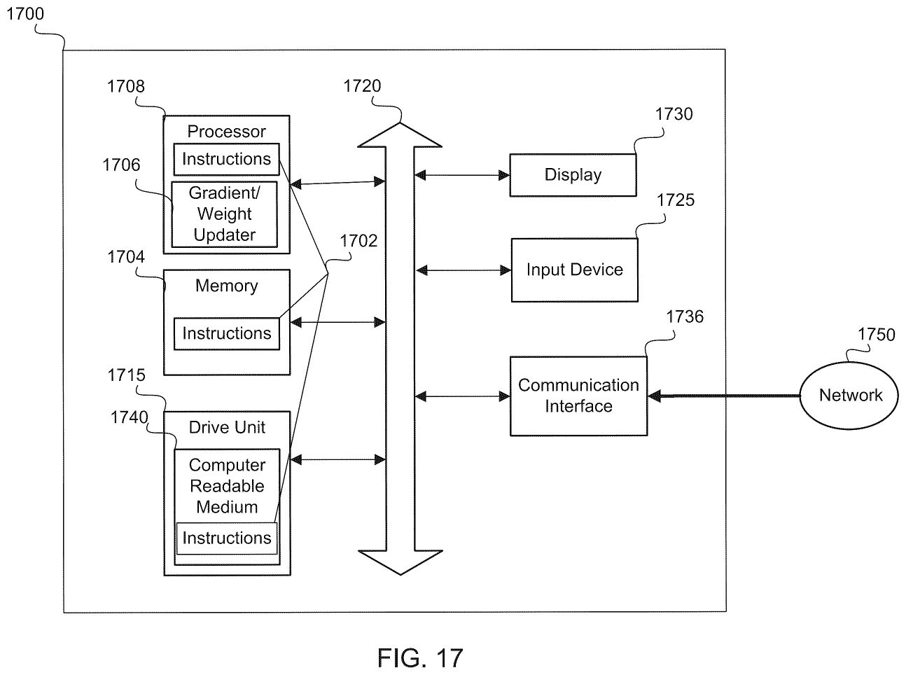

In some embodiments, RF active reflectors can be designed in several ways, some of which are illustrated in FIG. 14A, FIG. 14C, and FIG. 14D. Architectures of FIG. 14A and FIG. 14D may employ a switch-based scheme and an LNA-based scheme, respectively, to perform a square-wave modulation of the received signal at the desired frequency. These architectures have the benefit of simplicity at the cost of introducing harmonics, which may degrade the spectral efficiency of the system and limit the number of concurrently active reflectors. Practical implementation of types of reflectors are presented in FIG. 15 and FIGS. 16A-16B. For example, FIG. 15 is an exemplary amplifier-based, frequency-coded reflector for a radar spoofing attack according to an embodiments. Further, FIG. 16A and FIG. 16B are a millimeter, switch-based radar reflectors for short-range positioning, according to some embodiments. Architecture of FIG. 14C uses a modulator to perform FDM or BPSK.

FIG. 17 is a block diagram of an example computer system 1700 in which embodiments of the present disclosure can operate. For example, the computing system 1700 can be a computing device that executes digital signal processing of any of the converted electromagnetic signal disclosed herein. The computer system 1700 may include an ordered listing of a set of instructions 1702 that may be executed to cause the computer system 1700 to perform any one or more of the methods or computer-based functions disclosed herein. The computer system 1700 may operate as a stand-alone device or may be connected to other computer systems or peripheral devices, e.g., by using a network 1750.

In a networked deployment, the computer system 1700 may operate in the capacity of a server or as a client-user computer in a server-client user network environment, or as a peer computer system in a peer-to-peer (or distributed) network environment. The computer system 1700 may also be implemented as or incorporated into various devices, such as a personal computer or a mobile computing device capable of executing a set of instructions 1702 that specify actions to be taken by that machine, including and not limited to, accessing the internet or web through any form of browser. Further, each of the systems described may include any collection of sub-systems that individually or jointly execute a set, or multiple sets, of instructions to perform one or more computer functions.

The computer system 1700 may include a memory 1704 on a bus 1720 for communicating information. Code operable to cause the computer system to perform any of the acts or operations described herein may be stored in the memory 1704. The memory 1704 may be a random-access memory, read-only memory, programmable memory, hard disk drive or other type of volatile or non-volatile memory or storage device.

The computer system 1700 may include a processor 1708, such as a central processing unit (CPU) and/or a graphics processing unit (GPU). The processor 1708 may include one or more general processors, digital signal processors, application specific integrated circuits, field programmable gate arrays, digital circuits, optical circuits, analog circuits, combinations thereof, or other now known or later-developed devices for analyzing and processing data. The processor 1708 may implement the set of instructions 1702 or other software program, such as manually-programmed or computer-generated code for implementing logical functions. The logical function or system element described may, among other functions, process and/or convert an analog data source such as an analog electrical, audio, or video signal, or a combination thereof, to a digital data source for audio-visual purposes or other digital processing purposes such as for compatibility for computer processing.

The computer system 1700 may also include a disk (or optical) drive unit 1715. The disk drive unit 1715 may include a non-transitory computer-readable medium 1740 in which one or more sets of instructions 1702, e.g., software, can be embedded. Further, the instructions 1702 may perform one or more of the operations as described herein. The instructions 1702 may reside completely, or at least partially, within the memory 1704 and/or within the processor 1708 during execution by the computer system 1700.

The memory 1704 and the processor 1708 also may include non-transitory computer-readable storage media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 1700 may include an input device 1725, such as a keyboard or mouse, configured for a user to interact with any of the components of computer system 1700. It may further include a display 1730, such as a liquid crystal display (LCD), a cathode ray tube (CRT), or any other display suitable for conveying information. The display 1730 may act as an interface for the user to see the functioning of the processor 1708, or specifically as an interface with the software stored in the memory 1704 or the drive unit 1715.

The computer system 1700 may include a communication interface 1736 that enables communications via the communications network 1710. The network 1710 may include wired networks, wireless networks, or combinations thereof. The communication interface 1736 network may enable communications via a number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. A computer system or other apparatus adapted for carrying out the methods described herein is suited to the present disclosure. A typical combination of hardware and software may be a general-purpose computer system with a computer program that, when being loaded and executed, controls the computer system such that it carrying out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

The disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms, operations, and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the disclosure is not described with reference to any particular programming language. It will be appreciated that a variety of programming languages can be used to implement the teachings of the disclosure as described herein.

The disclosure can be provided as a computer program product, or software, that can include a machine-readable medium having stored thereon instructions, which can be used to program a computer system (or other electronic devices) to perform a process according to the disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” or the like throughout is not intended to mean the same implementation or implementation unless described as such. One or more implementations or embodiments described herein may be combined in a particular implementation or embodiment. The terms “first,” “second,” “third,” “fourth,” etc. as used herein are meant as labels to distinguish among different elements and may not necessarily have an ordinal meaning according to their numerical designation.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A radar system comprising:
at least one antenna positioned opposite from at least one reflector with an area under test therebetween having a particle-medium mixture, the at least one antenna to emit, at the reflector, a series of chirps within a first electromagnetic signal and to receive a second electromagnetic signal that includes reflected chirps that bounce off the reflector;
an analog-to-digital converter (ADC) coupled to the at least one antenna, the ADC to convert the second electromagnetic signal to a digital signal containing phase, frequency, and amplitude information; and
a processing device coupled to the ADC, the processing device to process the digital signal to:
detect raw phase data of reflector peaks to be tracked over the reflected chirps;
unwrap the raw phase data into a continuous phase-based signal;
correct for phase non-linearities within the continuous phase-based signal; and
generate, from the corrected continuous phase-based signal, a path-integrated particle number density for the particle-medium mixture.

2. The radar system of claim 1, wherein the radar system is a frequency-modulated continuous-wave (FMCW) radar system, and where the radar system further comprises transmit/receive modules to switch between transmit and receive modes.

3. The radar system of claim 1, further comprising a transceiver coupled to the at least one antenna, the transceiver to cause the series of chirps to be emitted within a microwave range of frequencies and over a time period of tens of nanoseconds to thousands of microseconds.

4. The radar system of claim 1, wherein the processing device is further to:
reshape raw radar data captured by the ADC into a two-dimensional array;
process the reshaped raw radar data with a convolution technique to convert time domain data to the frequency domain, wherein the technique comprises one of the Fourier Transform, chirplet transform, wavelet transform, Gabor transform, Hilbert transform, Hadamard transform, Z-transform, Laplace transform, or a combination thereof; and
detect, within each frequency domain chirp, a reflector peak having a range that is proportional to a frequency of the reflector peak.

5. The radar system of claim 4, wherein the antenna comprises an antenna array, and wherein the processing device is further to convert spatial data to the frequency domain also along a dimension of the antenna array to generate an angle-of-arrival (AoA) detection of the reflected chirps and determine a range-angle spectrum using AoA-based information.

6. The radar system of claim 1, wherein the processing device is further to filter and correct for hysteresis, thermal drift, and negative phase of the continuous phase-based signal to correct for the non-linearities.

7. The radar system of claim 1, wherein the path-integrated particle number density is linearly proportional to a phase shift calculated as
$$Δ ϕ = \frac{2 π}{{λ}_{0}} {\int }_{L} ( \sqrt{{ε}_{1}} - \sqrt{{ε}_{0}} ) dl = \frac{2 π \sqrt{{ε}_{0}}}{{λ}_{0}} {\int }_{L} ( \sqrt{1 + α} - 1 ) dl \approx \frac{π \sqrt{{ε}_{0}}}{{λ}_{0}} {\int }_{L} α dl ,$$
where εᵢ is a relative permittivity of the given particle-medium mixture.

8. The radar system of claim 1, wherein the particle-medium mixture comprises at least one of an optically opaque dielectric object, fluid, or plasma.

9. A system comprising:
a plurality of reflectors; and
a radar system positioned opposite from the plurality of reflectors with an area under test therebetween having a particle-medium mixture, wherein the radar system comprises:
a plurality of antennas to emit a plurality of chirp signals at the plurality of reflectors and to receive a plurality of electromagnetic signals that include reflected chirps that bounce off of respective ones of the plurality of reflectors;
a mixer circuit coupled to the plurality of antennas, the mixer circuit to distinguish the plurality of electromagnetic signals as associated with a particular chirp signal of the plurality of chirp signals;
an analog-to-digital converter (ADC) coupled to the mixer circuit, the ADC to convert the plurality of electromagnetic signals to a plurality of digital signals containing phase, frequency, and amplitude information; and
a processing device coupled to the ADC, the processing device to process each digital signal of the plurality of digital signals to:
detect raw phase data of reflector peaks to be tracked over the reflected chirps;
unwrap the raw phase data into a continuous phase-based signal;
correct for phase non-linearities within the continuous phase-based signal; and
generate, from the corrected continuous phase-based signal, a path-integrated particle number density for the particle-medium mixture;
wherein, the processing device is further to generate tomographic data indicative of the path-integrated particle number density over a plurality of paths associated with respective antennas of the plurality of antennas.

10. The system of claim 9, wherein the radar system is a frequency-modulated continuous-wave (FMCW) radar system, and where the radar system further comprises transmit/receive modules coupled to the plurality of antennas, the transmit/receive modules to switch between transmit and receive modes.

11. The system of claim 9, wherein the plurality of reflectors comprise passive reflectors, wherein each carrier frequency is controlled by a distance to a corresponding passive reflector, and wherein the processing device is configured to process the plurality of digital signals to generate range-resolved tomographic data.

12. The system of claim 9, wherein the plurality of reflectors comprise modulated active reflectors located equidistant from the radar system, and wherein the processing device is configured to process the plurality of digital signals to generate frequency-resolved tomographic data.

13. The system of claim 12, wherein the modulated active reflectors are one of switched-based, vibration-based, mixed-based, or amplifier-based reflectors.

14. The system of claim 9, wherein the plurality of reflectors comprise passive reflectors located equidistant from the radar system, which are one of phased-arrayed or mechanically-steered, and wherein the processing device is configured to process the plurality of digital signals to generate angle-resolved tomographic data.

15. The system of claim 9, wherein the processing device is further to:
reshape raw radar data captured by the ADC into a two-dimensional array;
process the reshaped raw radar data to convert each reflected chirp from the time domain into a frequency domain chirp; and
detect, within each frequency domain chirp, a reflector peak having a range that is proportional to a frequency of the reflector peak.

16. The system of claim 15, wherein the plurality of antennas comprises an antenna array, and wherein the processing device is further to convert spatial data to the frequency domain also along a dimension of the antenna array to generate an angle-of-arrival (AoA) detection of the reflected chirps and determine a range-angle spectrum using AoA-based information.

17. The system of claim 9, wherein the processing device is further to filter and correct for hysteresis, thermal drift, and negative phase of the continuous phase-based signal to correct for the non-linearities.

18. The system of claim 9, wherein the radar system is to emit the plurality of chirps at within a microwave range of frequencies and over a time period of tens of nanoseconds to thousands of microseconds.

19. The system of claim 9, wherein the particle-medium mixture comprises at least one of an optically opaque dielectric object, fluid, or plasma.

20. A method comprising:
converting, by an ADC of a radar system, a reflective electromagnetic signal received from one or more reflectors, to a digital signal containing phase, frequency, and amplitude information;
processing, by the radar system, the digital signal by:
detecting raw phase data of reflector peaks to be tracked over the reflected chirps;
unwrapping the raw phase data into a continuous phase-based signal;
correcting for phase non-linearities within the continuous phase-based signal; and
generating, from the corrected continuous phase-based signal, a path-integrated particle number density for a particle-medium mixture under test.

21. The method of claim 20, further comprising generating tomographic data indicative of the path-integrated particle number density over one or more paths associated with one more antennas of the radar system.
